(19) United States
(12) Patent Application Publication
(10) Pub. No.: US 2015/0059926 A1
(43) Pub. Date: Mar. 5, 2015

(54) WOOD COLUMN REPAIR, REINFORCEMENT, AND EXTENSION

(71) Applicant: Mohammad R. Ehsani, Tucson, AZ (US)

(72) Inventor: Mohammad R. Ehsani, Tucson, AZ (US)

(21) Appl. No.: 14/017,780

(22) Filed: Sep. 4, 2013

(51) Int. Cl. E02D 5/64; E02D 5/52; B27M 1/08

(52) U.S. Cl. CPC E02D 5/64; B27M 1/08; E02D 5/526
USPC 144/330; 405/251

(57) ABSTRACT

Methods and systems of repairing and/or extending wood piles and columns are disclosed. In these methods and systems a portion of the wood pile is removed and replaced by a preferable timber section. To strengthen the pile after addition of the new section, strips or sheets of reinforcing material is attached along the length of the new section of the pile such that the reinforcing material extends over the old part(s) of the pile and crosses over the joint or interface of the old and new parts of the pile. Subsequently a shell is provided around the new section of the pile and its attached reinforcing material and the annular space between the shell and the pile is filled with resin or similar materials.

### TECHNICAL FIELD

This application relates generally to construction. More specifically, this application relates to methods and apparatus for extending and/or reinforcing and repairing wood columns and piles.

### BRIEF DESCRIPTION OF THE DRAWINGS

The drawings, when considered in connection with the following description, are presented for the purpose of facilitating an understanding of the subject matter sought to be protected.

FIG. 1 shows an example deteriorated column suitable to be repaired and reinforced by the disclosed method;

FIGS. 2A and 2B show an example step in a process of replacing and reinforcing a wood column; and

FIGS. 3A and 3B show an example of additional steps in the process of replacing and reinforcing a wood column.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references using example reinforcement layers and materials, it will be appreciated that the disclosure may include fewer or more reinforcement layers and other types of materials.

Briefly described, a method and a system are disclosed for adding to or replacing a part of wood columns/piles and externally reinforcing the wood columns/piles (hereinafter referred to as either “column” or “pile”). Wood columns are widely used to support buildings, bridges, floors, utility and electrical power lines and the like. In general, timber piles are extensively used in the construction industry. There are large number of piles in buildings, bridges, ports, railroad bridges, etc. that require repair and strengthening worldwide. For example, many piers in ports are supported on timber piles. Due to successful efforts of agencies such as the Environmental Protection Agency (EPA), the cleaning of waterways and lakes has resulted in a resurgence of marine borers and other creatures that could not survive in polluted water. This has resulted in an alarming increased rate of deterioration in such piles. These bugs eat away the wood from outside or inside, reducing the cross sectional area of the pile which can result in disastrous failure of the structure being supported on such piles. These piles require an effective method for repair and strengthening.

In another example, many beach-front homes are supported on timber piles that are embedded in soil or water. Global warming and change in climate patterns have led to development of frequent strong storms and rise in water elevations that can topple these homes. The recent 2012 Hurricane Sandy, for example, resulted in major loss of property along the coastlines in New Jersey. In response to such disasters, government agencies such as the Federal Emergency Management Administration (FEMA) have redrawn flood maps and many property owners are mandated to raise their homes by several feet to be eligible for insuring their buildings. The existing technique for addressing this problem is to support the home on a series of stiff steel beams and jacks. Piles are cut and homes are raised by multiple jacks. In many cases homes must be also moved away from their original locations. The piles are replaced with new taller piles and the houses are driven back to the original locations and are set atop their new piles. It is obvious that this operation is very expensive and requires the homes to be on large enough lots to accommodate the homes while the piles are being fixed; however, most beach front homes are on very small lots and the aforementioned repair technique is not a viable solution. As a result, there is a tremendous interest in techniques for extending the length of a pile without the need to move the house away from its footprint.

Another example of repair is timber utility poles. These poles become weaker as they age. At the same time, addition of new power lines or antennas for telecommunication and wireless services to these aging poles place heavier loads on the poles. This leads to the need for strengthening of these poles. The strong winds during storms and tornados result in breakage of the poles and lead to power outages.

Timber piles are also used extensively in construction of railroad bridges. These piles have also weakened after decades of use. The present methods can repair and strengthen these piles as well. The above are only samples of the applications of the present methods. Numerous other applications in mining industry and other fields also exist which are obvious to those skilled in the art.

The disclosed methods and systems may be used to: (1) Repair and/or strengthen damaged timber piles by removing and replacing the damaged portion, and/or (2) Extend the height of a pile, which may be otherwise in good shape. In these applications, since the pile is cut, there may be one or more splice locations that usually become the weakest point in the pile. Disclosed methods strengthen the splice connections in such a way that the repaired or the extended columns become even stronger than the remaining original portions of the piles.

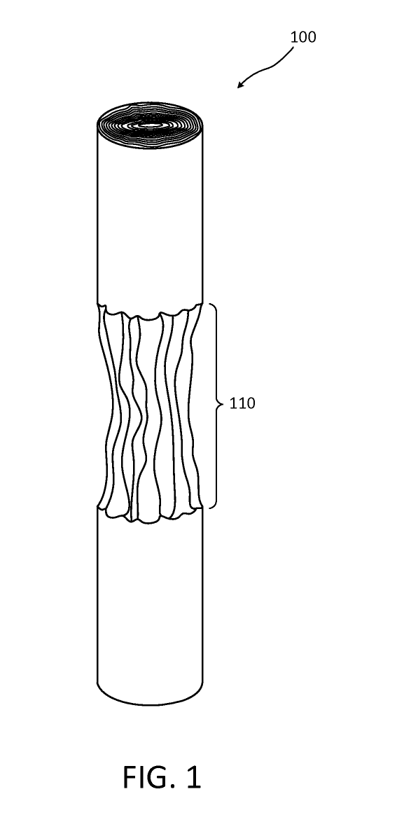

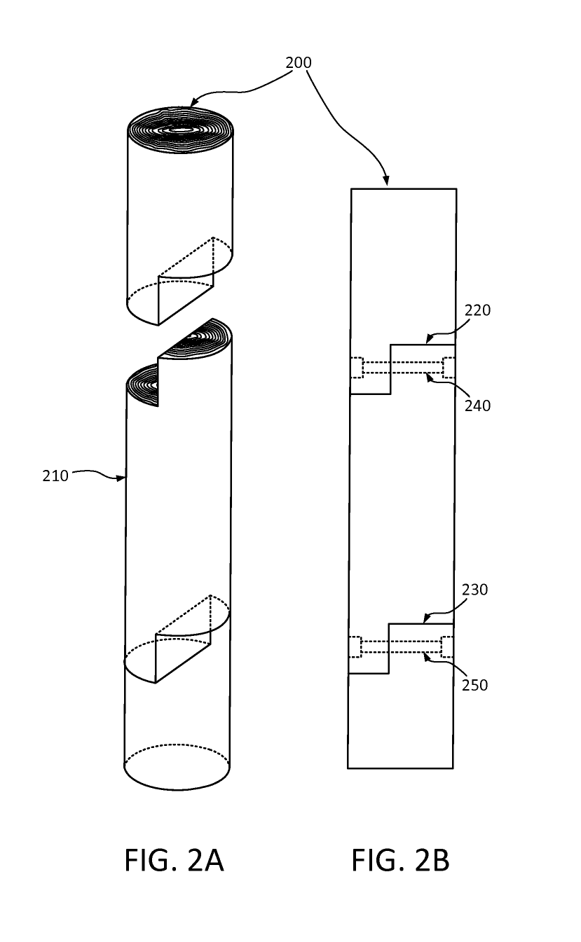

FIG. 1 shows an example timber pile 100 with the portion 110 of the pile severely deteriorated, which requires strengthening. Without repair or strengthening, portion 110 of pile 100 may buckle under load. In one embodiment, the damaged section 110 of the pile 100 is cut and removed. The splice cut can be of many types used in wood construction, such as a half-lap splice (Shown in FIGS. 2A and 2B), bevel-lap splice, flush cut, diagonal (sloping) cut, etc. Care must be taken to ensure that the structure does not collapse during this stage of the operation. Such preventive methods are commonly known to those skilled in the art and therefore are not discussed here in great detail. For example, in some cases the structure can be supported by positioning temporary columns in the vicinity of the damaged pile 100 such that the temporary columns carry the loads while the damaged pile 100 is being repaired. In another example, temporary sister piles, made of steel or timber, are bolted to the damaged pile 100 at points above and below the damaged area 110. This allows the loads to bypass the damaged area 110 and pile 100 will maintain its original height while the damaged portion 110 is being cut and removed.

FIGS. 2A and 2B show an example step in the process of replacing and reinforcing wood column 200. In this example, the deteriorated section of column 200 has already been cut away using two half-lap splices 220 and 230, shown in FIG. 2A, and has been replaced by a new section 210 of timber pile or other material such as steel, preferably with the same length and cross sectional dimensions as the removed section, as shown in FIG. 2B. Steel bolts 240 and 250, or other anchoring means, may also be used to secure the top and bottom of the new pile segment 210 to the original pile. Those skilled in the art will appreciate that the replacement spliced section of the pile may be attached to the pile using other methods, such as using glues, double-sided joints, plates, and the like, without departing from the spirit of the present disclosure.

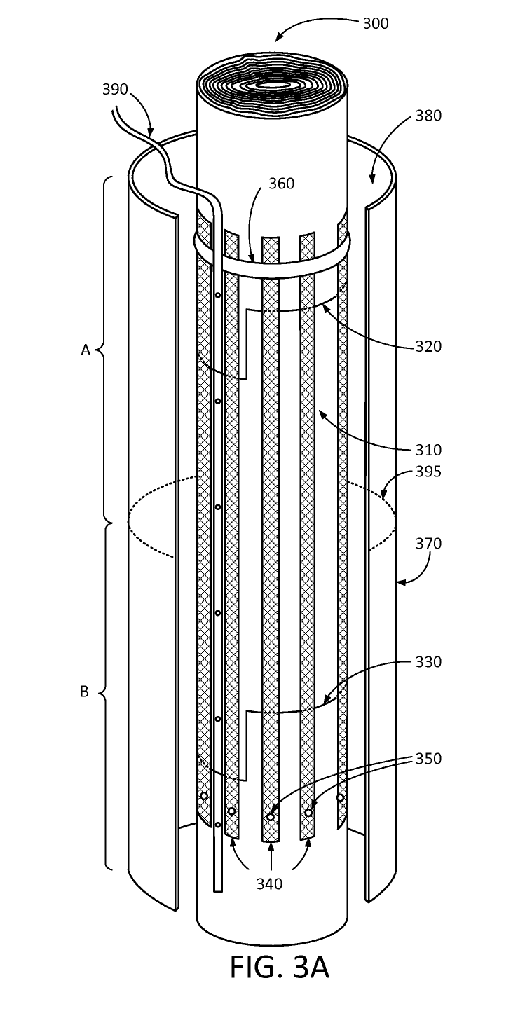

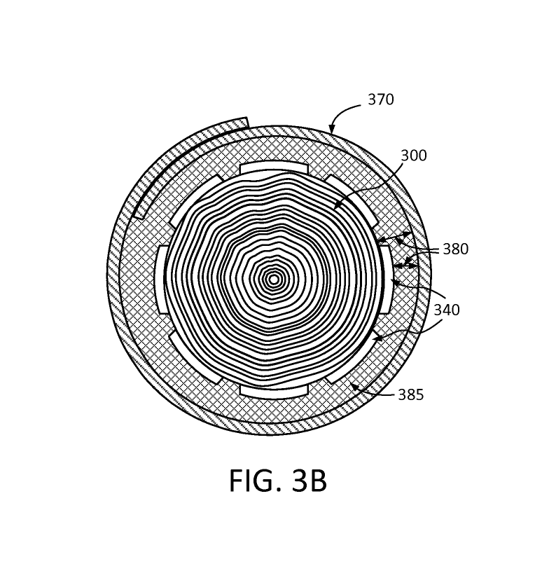

FIG. 3A shows an example of further steps in the process of replacing and reinforcing a wood column. As shown in this figure and described below, to restore the flexural axial and shear strength of a wood pile after replacement of its deteriorated portion, additional reinforcing elements are placed around the perimeter of the pile. In some embodiments, for example, as shown in FIG. 3A, reinforcing strips 340, such as QuakeWrap® GU50C Carbon strips that are supplied in 2 to 4 inch wide by 0.05 inch thick strips and that can be cut to any length, are held substantially longitudinally against wood column 300. In various embodiments these reinforcing elements 340 may be glued or nailed to column 300 such as by nails 350, or be held in place by strap 360. In some embodiments each reinforcing strip 340 may extend over one or two cut joints 320 and 330. In the embodiment of FIG. 3A, all reinforcing strips 340 extend over both cut joints 320 and 330. In some embodiments the reinforcing strips 340 may be separated by a gap; placed side by side and in contact each other; or even partially overlapping each other. FIG. 3A only shows reinforcing strips 340 being at a distance from each other. Those skilled in the art will appreciate that in some embodiments the width of one reinforcing element 340 may be as much as the entire perimeter of column 300, such that a single reinforcing element 340 can cover the entire circumference of column 300. In such an embodiment, a single reinforcing element 340 replaces and performs as multiple side-by-side reinforcing strips.

The reinforcing elements 340 can be made of wood, metals such as steel, stainless steel or non-metallic materials such as Carbon, Glass, Kevlar or Basalt Fiber Reinforced Polymer (FRP) materials, etc., and may be made in the form of solid, twisted fibers, mesh, or other suitable configurations. The reinforcing elements 340 can be in the shape of rods, flat plates, woven fibers and strips as well as a reinforcing grid. While an easy installation technique is to place the reinforcing elements 340 around the pile 300, the reinforcing elements 340 may even be embedded into vertical/longitudinal grooves that are cut along the length of the timber. To those skilled in the art, this is known as Near-Surface-Mounted (NSM) reinforcement. In various embodiments, the reinforcing elements 340 may vary in thickness, width, and cross sectional shape along their length to provide more reinforcement near joints at splice locations 320 and 330, while saving material and cost farther away from joints where relatively it is needed less.

The length of the reinforcing elements 340 and how far they extend beyond a splice location are design issues, the specifics of which are usually calculated by an engineer. Since the splice locations 320 and 330 are generally the weakest point in the pile 300, the reinforcing elements 340 are recommended to extend beyond the splice locations a distance at least equal to their development length. This length is a function of the strength of the reinforcing element 340 and its surface texture or bond characteristics. For example, for QuakeWrap® GU50C Carbon strips this length is approximately 12-18 inches, depending on the mechanical characteristics of the resin that is being injected in the annular space, described below. Other reinforcing elements will have shorter or longer development lengths that can be calculated by the design engineer.

As shown in FIG. 3A, after placing reinforcing elements 340 over column 300, at least one reinforcing sheet 370 is wrapped one or more times around column 300 to form a reinforcing shell that encloses column 300 and reinforcing elements 340. In various embodiments, the overlapping edges of a wrapped reinforcing sheet 370 are glued or otherwise attached to each other to form the reinforcing shell. In some embodiments a wrapped reinforcing sheet 370 may stay at a distance from reinforcing elements 340 and in other embodiments a wrapped reinforcing sheet 370 may touch the reinforcing elements 340. It is preferable for a wrapped reinforcing sheet 370 (reinforcing shell) to completely enclose the new part of the pile along with a part of the original pile and completely enclose the reinforcing elements 340; however, the reinforcing shell may be made of more than one reinforcing sheet wrapped in succession along the length of the pile. In such embodiments two or more reinforcing sheets may be used to construct a longer reinforcing shell. These partial reinforcing shells may be joined overlappingly or by other means known to those skilled in the art. For example, reinforcing sheet 370 in FIG. 3A may be formed by two separate sections A and B which are joined along the dash-line 395.

In addition to providing tensile, bending, shear, and depending on material used, compression strength, the reinforcing elements 340 may also serve as spacers between the surface of the pile 300 and the reinforcing sheet 370. In other embodiments additional and separate spacers can be used to ensure proper separation between the pile surface and the reinforcing sheet 370. These spacers can be made of plastic, wood, steel and the like. An inexpensive solution is to use the 2-15 mm diameter wooden rods commonly used in arts and crafts projects. These spacers can be glued or mechanically attached to the timber pile using nails or other fasteners. The space created between the pile and the reinforcing sheet may be filled with reinforcing material, such as grout or concrete, as further described below.

For example, to create the reinforcing shell around pile 300, PileMedic™ PLC 100.60 carbon FRP laminate is coated with an epoxy paste adhesive such as QuakeWrap® 220UR Underwater Resin and is wrapped around pile 300 more than once. The number of layers of this wrap is based on engineering calculations and directly determines the level of strengthening that is introduced to the pile. For example, two layers of PileMedic™ PLC100.60 wrap provide a confining pressure of 800 psi on a 12-inch diameter pile while 3 layers of the same wrap will provide a confining pressure of 1200 psi. Similarly in terms of contribution of forces along the axis of the pile which are significant to flexural strength of the pile, two layers of PileMedic™ PLC100.60 wrap provide 3000 pounds of tensile force per inch around the perimeter of the pile, while three layers of the same wrap provide 4500 pounds per inch of perimeter. The reinforcing sheet 370 is typically supplied in rolls that are 4 feet wide. So, each multilayer wrap will cover 4-feet along the height of a pile. Additional wraps can be applied with overlap lengths that are determined based on engineering calculations. The overlap must be calculated such that it does not constitute a weak point along the length of the pile in the finished shell. As many wraps as necessary will be applied to cover the entire repair area which typically extends 6 inches beyond the ends of the reinforcing elements 340.

The reinforcing sheet 370 can be a pre-cured laminate as described above or it can be a fabric such as QuakeWrap® TB20C Carbon fabric that is saturated in the field with a polymer such as an epoxy resin similar to QuakeBond™ J300SR Saturating Resin to form a composite material. The resin can be applied in advance to the fabric in what is commonly known as a pre-preg fabric. The resin can be cured in the field by ambient condition, heat, ultraviolet rays, etc. Resins that are activated upon contact with water, such as spraying the pre-preg fabric with water, can also be used.

At this stage, resin or other adhesive materials is poured or injected in the space between the wrapped reinforcing sheet 370 and column 300. In FIGS. 3A and 3B, this space has an annular shape. In some embodiments provisions are made to prevent the leakage of the resin from the bottom of the space between the wrapped reinforcing sheet 370 and column 300. For example, in some embodiments the bottom of the shell is sealed, for example, by an expansive chemical grout, an epoxy paste, a mechanical band such as a hose clamp, an adhesive tape, or the like. Resin will firmly attach the reinforcing sheet 370, the reinforcing element(s) 340, and column 300 together. In some embodiments, before the installation of the reinforcing sheet 370, resin may be used to glue the reinforcing element(s) 340 to column 300.

For injection of resin into space 380, one or more injection tubes 390 may be positioned along the height of the pile, which can be of any material such as copper or plastic tubing with a small diameter of about 3-15 mm. The injection tubes 390 may also include large holes along their length for easy dispersion of resin. In another embodiment, the injection tubes 390 can be partially hidden in vertical grooves that are cut along the length of the pile 300. The injection tubes can be held in position with, for example, tacks or staples and the like.

The space between the shell and the pile may be filled, for example, with a polymer such as QuakeBond™ 320LV Low Viscosity resin. This resin can be mixed in advanced and introduced into the space through the injection tubes. As the resin comes out of the bottom of the injection tubes, the injection tube can be slowly pulled up towards the top of the pile 300. If more than one injection tube is used, they may be connected together through a manifold to make sure that the resin is simultaneously introduced all around pile 300 into the space between the reinforcing sheet 370 and pile 300. The low viscosity of the mentioned example resin allows it to penetrate into the tiniest voids, cracks and crevices of the pile 300, including the bolt holes and the cut splice surfaces 320 and 330, where the new and the old pile sections are joined together. This results in a solid section of the pile that is significantly stronger than the original pile.

The above method whereby the epoxy is fed through gravity flow causes a passive confinement of the pile. That is, the shell around the pile will become activated only when the pile is loaded axially and starts to dilate outwards due to Poisson's effect. In another embodiment, the top portion of the annular space can also be sealed tightly and the resin can be pressurized inside the annular space. This pressurization of the resin causes the reinforcing shell to immediately exert a confining pressure on the pile. This method is known as active confinement and can further enhance the strength of the pile.

FIG. 3B shows a cross-sectional view of column 300 after installation of the reinforcing sheet 370, the reinforcing elements 340, and pouring of resin 385 into space 380. Once pile 300 has been repaired, the temporary pile-supports can be removed and the loads will be transferred to the newly repaired pile 300, wherein at some locations along the length of column 300 the loads are carried by the entire assembly of pile 300, reinforcing parts 340 and 370, and the cured resin 385.

In many cases homes and other coastal buildings have to be raised several feet to new elevations to satisfy the government requirements for minimum clearance above new flood levels. This usually requires that the piles supporting the building (that are not particularly damaged) be extended in height by, for example, several feet. In such cases, it may be most cost effective to cut a short piece of the pile directly below the house, where it is attached to the house, and replace the cut section with a taller section of timber that will be connected to the lower portion of the existing pile according to the disclosed methods. The advantage of cutting the top portion of the pile is that the repair requires strengthening of a single splice and will be more cost effective than adding a taller timber to the middle of the pile.

It is important to note that the repair and reinforcement methods disclosed above may be used without the removal of the deteriorated part of a pile. In cases in which the removal of the deteriorated part of a column does not seem to be necessary, all the steps of the mentioned methods may be carried out without the replacement step. In such cases, the limits of the deteriorated part must be treated as splice locations and the reinforcing materials and the reinforcing shell should be extended over the non-deteriorated sections beyond these limits.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of repairing or reinforcing a deteriorated wood pile, the method comprising:
removing a deteriorated middle part of the wood pile by cutting the wood pile in at least two locations;
replacing the cut portion of the wood pile with a desired new part;
placing one or more reinforcing materials over the splice locations of the wood pile such that the reinforcing materials extend from one direction over the new part and from another direction over the adjoining original wood pile section;
wrapping one or more reinforcing sheets around the wood pile to form a reinforcing shell such that the reinforcing shell encloses the new part of the pile and a part of each adjoining original wood pile section; and
filling a space between the reinforcing shell and the wood pile with an adhesive material.

2. The method of claim 1, wherein the adhesive material is resin or epoxy.

3. The method of claim 1, further comprising creating longitudinal grooves in the wood pile and the new part and placing the reinforcing materials within the grooves.

4. The method of claim 1, wherein reinforcing materials are in strip form.

5. The method of claim 1, wherein the new part is non-timber.

6. The method of claim 1, wherein the reinforcing shell is made of partial shells formed side by side along the length of the wood pile.

7. The method of claim 1, wherein the adhesive material is poured or forced under pressure into the space between the reinforcing shell and the wood pile.

8. The method of claim 1, wherein the reinforcing materials are made of wood, metal, steel, stainless steel, non-metallic materials, Carbon, Glass, Kevlar or Basalt Fiber Reinforced Polymer (FRP) materials.

9. The method of claim 1, wherein the reinforcing sheet is a pre-cured laminate or a fabric saturated with uncured polymer.

10. A method of extending a wood column, the method comprising:
splicing a new part to an end of the wood pile by cutting the wood pile on one end and replacing the cut portion of the wood pile with the new part or by merely adding the new part to the end of the wood pile;
placing one or more reinforcing materials over the splice location such that the reinforcing materials extend over both adjoining parts of the wood pile;
wrapping one or more reinforcing sheets around the wood pile to form a reinforcing shell that extends over the splice location and over a section of both adjoining parts of the wood pile; and
filling a space between the reinforcing shell and the wood pile with an adhesive material.

11. The method of claim 10, wherein the adhesive material is polymer, resin or epoxy.

12. The method of claim 10, wherein reinforcing materials are strips of material.

13. The method of claim 10, wherein the new part is non-timber.

14. The method of claim 10, wherein the adhesive material is poured or forced under pressure into the space between the reinforcing shell and the wood pile.

15. The method of claim 10, wherein the reinforcing materials are made of wood, metal, steel, stainless steel, non-metallic materials, Carbon, Glass, Kevlar or Basalt Fiber Reinforced Polymer (FRP) materials.

16. The method of claim 10, wherein the reinforcing sheet is a pre-cured laminate or a fabric saturated with uncured polymer.

17. A wood pile repair or extension kit, the kit comprising:
a new pile section to replace a deteriorated section of the wood pile or to add to the length of the wood pile;
reinforcing strips to be placed over one or more splice locations of the wood pile such that the reinforcing strips extend from one direction over the new pile section and from another direction over the adjoining original wood pile section;
reinforcing sheets to be wrapped around the wood pile to form a reinforcing shell such that the reinforcing shell encloses a part of the new pile section and a part of an adjoining original wood pile section; and
filling a space between the reinforcing shell and the wood pile with an adhesive material.

18. The method of claim 1, wherein at least one of the reinforcing strips and reinforcing sheets is made of woven or unwoven fibrous materials.

19. The method of claim 1, wherein the new part is non-timber.

20. The method of claim 1, wherein the adhesive material is poured or forced under pressure into the space between the reinforcing shell and the wood pile.
